(19) United States
(12) Patent Application Publication
(10) Pub. No.: US 2020/0081566 A1
(43) Pub. Date: Mar. 12, 2020

(54) Sensor and Devices Incorporating Sensors

(71) Applicant: THE UNIVERSITY COURT OF THE UNIVERSITY OF GLASGOW, Glasgow, Strathclyde (GB)

(72) Inventors: Ravinder DAHIYA, Glasgow (GB); Carlos GARCIA NUÑEZ, Glasgow (GB)

(73) Assignee: The University Court of the University of Glasgow, Glasgow, Strathclyde (GB)

(21) Appl. No.: 16/487,040

(22) PCT Filed: Feb. 19, 2018
(86) PCT No.: PCT/EP2018/054006

§ 371 Date: Aug. 19, 2019

(30) Foreign Application Priority Data
Feb. 20, 2017 (GB) 1702724.4

(51) Int. Cl. G06F 3/044

(52) U.S. Cl. CPC G06F 3/044; G06F 2203/04105; G06F 2203/04103; G06F 2203/04102

(57) ABSTRACT

This invention relates to a touch sensor having a layered structure, the layers including: a substrate; and a touch-sensitive layer formed of single-layer graphene and having a plurality of coplanar electrodes formed therein. Embodiments of the touch sensor are flexible and stretchable, making them suitable for use as an artificial skin. Further embodiments of the touch sensor are also capable of sensing pressure as well as touch. Further embodiments are substantially transparent and can therefore include a photovoltaic layer under the touch-sensitive layer which can provide a degree of energy autonomy. Further aspects of the invention provide prosthetic devices having such touch sensors forming a sensitive skin, and a method of manufacturing a touch sensor wherein interdigitated electrodes are cut in single-layer graphene by a blade-cutting process.

### FIELD OF THE INVENTION

The present invention relates to a sensor and devices incorporating such sensors. It is particularly, but not exclusively, concerned with sensors for providing touch sensitivity, for example for use as artificial skin.

### BACKGROUND OF THE INVENTION

Tactile or electronic artificial skin is needed to provide critical haptic perception to robots and amputees as well as in wearable electronics for health monitoring and wellness applications.

Real human skin is composed of countless neural sensors that are able to perceive various stimuli such as the pressure, temperature and texture of an object that they contact. In addition to its advanced sensing capability, our skin is mechanically flexible, stretchable, robust, and self-healing. Tactile or electronic skin (e-skin) is an artificial smart skin aiming to provide similar sense of touch to robots and artificial prostheses by mimicking some of the features of human skin [1-5]. In this regard, there is a desire to develop and integrate multiple sensors on non-planar, flexible and conformal surfaces, firstly to make it viable, and then to advance today's e-skin applications [6]. For example, a flexible skin provided with touch/pressure sensors will allow robots to detect the strength and location of the pressure exerted on the skin surface. Similarly, with different set of sensors the e-skin could also act as our second skin, allowing us to detect chronic diseases such as diabetes. To satisfy the requirements of such a system, active materials with intrinsic properties including good mechanical, electrical, optical, and structural properties are highly desirable.

The development of suitable flexible pressure sensors for e-skin applications to be applicable in practical robots has, to date, been a challenge due to one or more of: inadequate flexibility, conductivity, large-area manufacturability and reliable and repeatable performance of the structure. In this regard, only very few approaches have been successfully employed in actual robots [7-8].

Some flexible pressure sensors are reported in literature, based on capacitive [17-20], piezoelectric [21], and piezoresistive sensing mechanisms [2, 22-28], which use graphene as an active material. Piezoresistive sensors transduce the pressure imposed on the sensor active area in terms of resistance change and offer attractive solution for pressure sensing due to advantages such as low-cost, and easy signal collection. Graphene based piezoresistive pressure sensors have been reported in various configurations. For example, Yao et al. demonstrated the fabrication of flexible pressure sensors based on a graphene nano-sheets on polyurethane (PU) sponge [22]. The use of graphene nano-sheets as conductive coating on commercial PU sponge results in a high contact area of the conductive sponge and improves the sensitivity of the sensor (0.26 kPa⁻¹) at low pressure regimes (<2 kPa). However, the thick and non-transparent sponge-like structure prevents these sensors from being used if a transparent e-skin is desired. Following a similar approach, Zhu et al. used polydimethylsiloxane (PDMS) films with pyramid micro-structures as a substrate for the deposition of reduced graphene oxide (rGO) layers, resulting in microstructured rGO that demonstrated ultra-high sensitivity to the pressure [29]. The anisotropic pyramid microstructures-based rGO arrays not only provide the pressure sensor with high sensitivity 5.5 kPa⁻¹ at pressures ranging from 1.5 to 100 Pa, but also presented fast response times of 0.2 ms. However, the sensitivity of these sensors drops significantly at pressures above 5 kPa, which is a drawback when it comes to daily tasks where normal manipulation such as human object grabbing involves forces in the range of 0.15-0.9 N, and 90% of the mechanoreceptors can detect pressures as low as 8.5 kPa [30].

As mentioned above, the graphene pressure sensors can also be based on the capacitive mechanism [17-20]. Capacitive pressure sensors typically consist of two parallel plates separated with a soft dielectric material. The pressure applied normal to the sensor surface squeezes the material and reduces the gap between parallel plates, leading to a change of the measured capacitance. In this regard, Bao et al. fabricated a flexible pressure capacitive sensor array based on PDMS film sandwiched between two plastic substrates each of which contained a set of conductive lines, serving as an address and data lines [19]. The use of microstructured PDMS showed a maximum sensitivity of 0.55 kPa⁻¹, which is around 35 times higher than the sensitivity of unstructured PDMS in the same range of pressures. Moreover, by using the 6×6 pmt pyramid-structured PDMS as a dielectric layer on organic field effect transistors (OFETs), they were able to detect ultra-small weights of about 20 mg from the capacitance change. Similarly, Ho et al. reported transparent graphene oxide (GO) and rGO based multifunctional e-skin with humidity, thermal, and pressure sensors in a three dimensional (3D) structure [20]. However, the encapsulation of the pressure sensors in this 3D stacked structure appears to hinder the sensor performance, which shows a low sensitivity of 0.002 kPa⁻¹ at pressures up to 450 kPa.

An object of the present invention is to provide an e-skin which has a degree of, and preferably total, energy autonomy. This will enable or assist with portability and longer operation times for the skin.

### SUMMARY OF THE INVENTION

At its broadest, one aspect of the present invention provides a touch sensor formed from single layer graphene. Further aspects provide for touch sensors which are substantially transparent and therefore can be combined with a solar cell.

A first aspect of the present invention provides a touch sensor having a layered structure, the layers including: a substrate; and a touch-sensitive layer formed of single-layer graphene and having a plurality of coplanar electrodes formed therein.

Preferably the touch sensor further includes a coating layer formed on top of the touch-sensitive layer. More preferably the coating layer is formed of a polymer. The coating layer can not only protects the electrodes on the touch-sensitive layer from the environment (e.g. from dust or moisture, which may inadvertently short-circuit the electrodes or otherwise affect the sensitivity of the sensor), but may also contribute to the performance of the sensor by introducing a dielectric layer above the touch-sensitive layer.

Preferably the touch sensor is flexible. Single layer graphene is inherently flexible, and so by choosing the material for the substrate and coating layer, if present, (and any other layers) to be flexible as well, a flexible sensor can be constructed. This is of particular benefit where the sensor is to be applied to or used on non-uniform surfaces, for example on the surface of a prosthetic or artificial limb.

Preferably the touch sensor is resiliently stretchable. Single layer graphene is inherently resiliently stretchable, and so by choosing the material for the substrate and coating layer, if present, (and any other layers) to be flexible as well, a resiliently stretchable sensor can be constructed. This is of particular benefit when the sensor is to be used as a “skin” on a moving device, such as a prosthesis.

The touch sensitive layer based on single layer graphene can also have a very low power consumption which can aid energy autonomy, for example when combined with a photovoltaic layer as discussed further below. Preferably the touch sensitive layer has a power consumption in its resting state (i.e. when not being touched) of less than 50 nW/cm², more preferably less than 25 nW/cm².

Preferably the sensor is sensitive to pressure as well as touch. It certain embodiments, the sensor is made sensitive to pressure by arranging it such that the capacitance between the electrodes varies in relation to the pressure applied to the sensor. This may be in addition to, or as an alternative to variations in capacitance resulting from the interaction of the sensor with a proximate object (the sensing of “touch” alone).

The present inventors have determined that the sensitivity of graphene sensors to pressure may be originated by the change in the electrical properties of coating layer under pressure (and in particular where the coating layer is a polymer). The structural changes in the polymeric layer under pressure may lead to a change in the dielectric constant, which can directly affect the capacitance of the sensor.

Where the sensor is also a pressure sensor, the coating layer is therefore preferably present and is preferably one or more (and most preferably all) of: conformable; resiliently stretchable; resiliently deformable; and chemically inert.

In particular embodiments, it has been found that where the coating layer is a protective polydimethylsiloxane (PDMS) layer on the sensor's active area, a touch sensitive device can be created which can detect minimum pressure of 0.11 kPa with a sensitivity of 4.3 Pa⁻¹.

In particular embodiments, PVC is used as the substrate.

Various configuration of electrodes on the graphene layer are possible. In particularly preferred embodiments, the coplanar electrodes are interdigitated. The interdigitated structure contributes to the flexibility and resilient nature of the sensor. The interdigitation may take any known form, but is preferably rectangular.

Preferably the touch sensor is substantially transparent to ultra-violet, visible and/or near-infrared radiation. This feature is particularly advantageous in allowing the touch sensor to be combined with a photovoltaic cell, whilst retaining the touch sensor on the uppermost layer of the stack so that the operation and/or efficiency of the touch sensor is not diminished.

Preferably the touch sensor further include a photovoltaic layer capable of converting ambient radiation into electrical power, wherein the touch-sensitive layer and the polymer layer are stacked on top of the photovoltaic layer.

With the built-in photovoltaic layer or solar cell, the sensor of this aspect can have a degree of energy autonomy (or even complete energy autonomy). The transparent single layer graphene only absorbs between 0.75 and 2.75% of the UV/visible/IR radiation incident on it, with the remainder passing through the sensor layer to the solar cell.

Single layer graphene on PVC substrates has been characterized by spectrophotometry in transmittance and reflectance mode, using an integrative sphere to increase the accuracy of the characterization. Transmittance and reflectance of graphene on PVC was measured in the range of wavelengths from UV (350 nm) to near IR (1000 nm). Results show that graphene absorbs only 0.75-2.75% of the light along the whole measured wavelengths. The absorption of the PVC substrate was determined to be around 20%, however, since we are describing graphene properties we consider is not necessary to highlight this result.

Preferably the sensor has a single layer graphene based co-planar interdigitated capacitive touch sensor with a solar cell underneath.

Preferably the sensor also includes an energy storage layer. This could be, for example a battery, or preferably a super-capacitor. Examples of super-capacitors are given in [38]. Preferably the energy storage layer is positioned underneath the photovoltaic layer and therefore does not need to be transparent.

Preferably the sensor further includes a detection circuit configured to provide an output from the touch-sensitive layer, wherein the detection circuit is at least partly powered by the photovoltaic layer.

Due to the significant transparency of the sensors according to certain embodiments of the first aspect, it may be possible derive at least a proportion (and preferably all) of the power required to drive the detection circuit from the photovoltaic layer. A battery may still be needed (for example in order to ensure that the sensor still operates in low light conditions), but the photovoltaic layer may also be able to charge that battery when the detection circuit is not operating and light is incident on the sensor. It may also be possible to reduce the size (and therefore weight) of the battery as a result.

Considering the involvement of tactile sensors in various exploratory tasks in robotics and prosthetic applications, a pressure sensitivity range of 1-1000 kPa and a dynamic range of 1:1000 are desirable. In this regard, embodiments of the present aspect which use a foam-like structure based on laser-scribed graphene (LSG) demonstrate sensitivities of the piezoresistive pressure sensor up to 0.96 kPa⁻¹ in a wide pressure regime (0-50 kPa).

The sensors of this aspect can be used as a building block for a flexible and transparent tactile skin. However, other uses are also possible, for example in other arrangements in which flexible, resilient and/or transparent touch sensors may be useful, such as screens, displays or even windows.

A second aspect of the present invention provides a prosthetic or robotic device having a touch-sensitive skin, wherein the touch-sensitive skin is formed of a plurality of touch sensors according to the above described first aspect, including any of the optional or preferred features of such touch sensors in any combination.

For example, the touch sensors of the above first aspect may be used on the phalanges of a bionic hand or a robotic hand and can provide feedback of both touch and pressure relating to the interaction of that hand with objects.

Preferably the prosthetic or robotic device further includes a control circuit, wherein the control circuit is configured to determine a point of contact of an external object with the touch-sensitive skin based on touch signals generated in the touch-sensitive layers of one or more of the touch sensors.

Where one or more of the touch sensors include a photovoltaic layer, the movement of the prosthetic or robotic device may be at least partly powered by the photovoltaic layers of one or more of the energy-autonomous touch sensors.

Due to the significant transparency of the sensors according to certain embodiments of the above first aspect, it may be possible derive at least a proportion of the power required to drive the movement of the prosthetic or robotic device from solar calls included in the touch sensitive skin of the prosthetic device. These may act in conjunction with a battery (in order to ensure movement is still possible in low light conditions, but may also be able to charge that battery when the device is not being moved and light is incident on the skin. It may also be possible to reduce the size (and therefore weight) of the battery as a result.

The device of the present aspect may include any combination of some, all or none of the above described preferred and optional features.

A further aspect of the present invention provides a method of manufacturing a touch sensor, the method including the steps of: producing a sheet of single-layer graphene; forming, using blade cutting, a plurality of interdigitated electrodes on the single-layer graphene.

Interdigitated electrodes with different geometries and sizes can be fabricated in the graphene by blade-cutting which demonstrates a wide functionality and scalability of this technique.

The present inventors have analysed the electrical and morphological characteristics of the graphene after the blade-cutting process and found no or negligible negative effects due to the cutting process, even where complex patterns of electrodes are cut.

Blade-cutting is a rapid technique with high resolution comparable to that obtained with rapid techniques such as laser-cutting. However, compared to laser-cutting, blade-cutting prevents the degradation of the surrounding graphene, preserving its properties after the shaping of the interdigitated structure.

Blade cutting the graphene can thus enable rapid, large-area, and low-cost production of micrometric patterns in the single-layer graphene while preserving its properties.

The blade-cutting may be performed using an electronic cutting tool or similar and is preferably performed using a micrometric blade.

Blade-cutting can thus define the gap between the electrodes using a micrometric blade that affects only the area underneath the blade, preserving other areas at the periphery of the gap. In this regard, blade-cutting is a highly suitable substitute of techniques such as mask-lithography that need the direct mechanical contact of a mask on top of the entire area covered by graphene; this can produce irreversible damage on the graphene performance outside the cutting area after the patterning process.

Preferably the sensor, or at least the sheet of single-layer graphene and the electrodes formed thereon, is fabricated by a completely dry processing technique.

Dry processing using blade cutting is a novel and low-cost method to fabricate electrodes on single-layer graphene. In particular, dry processing using blade cutting has been demonstrated by the present inventors to substantial prevent or minimise damage to the properties of the graphene in the areas surrounding the cut(s).

The present inventors have determined that blade-cutting of electrodes on single-layer graphene is possible on both rigid and flexible substrates and demonstrates the potential for a high fabrication yield and good reproducibility.

Further, using blade cutting is reliable and highly scalable whilst avoiding many of the drawbacks associated with known techniques for defining patterns on graphene, such as graphene under-etching and contamination from the contacting mask (as experienced in mask lithography [35]), undesirable presence of residual polymers that contaminate the graphene surface (as experienced in photolithography [36]), low fabrication yield and harmful effects on atomically thick graphene layers (as seen in laser cutting [37]). Other known techniques such as laser scribing and helium ion microscopy [36, 37] are complex and costly and are also incompatible with plastic substrates.

Preferably the sheet of single-layer graphene is produced by transfer printing the graphene onto a flexible substrate, such as PVC.

The method of the present aspect may include any combination of some, all or none of the above described preferred and optional features.

### BRIEF DESCRIPTION OF THE DRAWINGS

Embodiments of the invention will now be described by way of example with reference to the accompanying drawings in which:

FIG. 1 shows the electro-mechanical characterisation of flexible graphene-on-PVC substrates which may be used in embodiments of the present invention.

FIG. 1 is a schematic illustration showing the fabrication steps of graphene based flexible capacitive touch sensors according to embodiments of the present invention. FIG. 2(a) shows hot lamination transfer printing of CVD graphene on PVC flexible substrate. FIG. 2(b) shows a graphene-on-PVC sample after etching the seed metal i.e. Cu. FIG. 2(c) shows Au deposition via e-beam evaporation through shadow mask. FIG. 2(d) shows patterning of graphene channel with an electronic cutting tool. FIG. 2(e) shows a flexible capacitive touch sensor after spin-coating and curing of PDMS protective layer. FIG. 2(f) shows the resultant graphene based capacitive touch sensor according to an embodiment of the present invention.

FIG. 2 shows graphene based flexible capacitive sensors according to embodiments of the present invention with various interdigitated patterns. FIG. 3(a) shows a flexible graphene-on-PVC sample with an interdigitated pattern. FIG. 3(b) is a photograph of graphene based flexible capacitive touch sensors with different geometries of interdigitated electrodes. FIG. 3(c) is an optical microscope image of the longitudinal cuts and its corresponding magnified image (d). FIG. 3(e) shows the profile of the cut measured with stylus profiler along the dashed line in FIG. 3(d).

FIG. 3 shows the measurement of the capacitive response of graphene based flexible sensors according to embodiments of the present invention. FIG. 4(a) is a schematic illustration of experimental setup. FIG. 4(b) shows the response of the graphene based flexible sensor under the quasi-static application of pressure overtime for various pressures; inset: extracted sensitivities for wide pressure regime. FIG. 4(c) illustrates co-planar and parallel based capacitors; type I capacitor is sensitive to touch and proximity, whereas type II and parallel capacitors are sensitive to pressure. FIGS. 4(d) & (e) are photographs of capacitive sensors according to embodiments of the present invention under test in flat and bending conditions. FIG. 4(f) shows ΔC/C₀ vs pressure measured in flat and bending conditions.

FIG. 4 shows the use of sensors according to embodiments of the present invention to create a prosthetic device according to a further embodiment of the present invention. FIG. 4(a) shows capacitive sensors integrated at the intermediate and proximal phalanges of i-Limb. FIGS. 5(b)-(e) show the ΔV/V₀ of all the capacitive sensors placed at proximal (b & c) and intermediate (d & e) phalanges, measured over time for touch operation with a gloved hand.

FIG. 5 shows a dynamic characterization of prosthetic limb fitted with graphene touch sensors “grabbing” a soft ball. FIGS. 6(a) and 6(b) show the differences between disabling or enabling the tactile feedback method set out below. FIGS. 6(c) and 6(d) are colour map of the capacitive sensors, showing the readout voltage modulation after grabbing with tactile feedback either disabled (c) or enabled (d). The inset of FIG. 6(d) shows a logic diagram used to control the grabbing of the hand with respect to the sensor readout.

FIG. 6 shows the heterogeneous integration of graphene transparent touch sensors atop a solar cell according to a further embodiment of the present invention. FIG. 7(a) is a 3D schematic illustration of the heterogeneous integration of graphene touch sensor on top of a solar cell. FIG. 7(b) shows the transmittance (T) and reflectance (R) spectra of single layer graphene-on-PVC and a PVC reference substrate; inset: absorbance of single layer graphene. FIGS. 7(c) and (d) show the I-V and P-V characteristics of the solar cell after the integration of samples consisting of PVC, graphene-on-PVC, and graphene-on-PVC with a PDMS protective layer.

FIG. 8 shows stylus profiler measurements of three different cuts carried out on graphene-on-PVC by using a Silhouette electronic cutting machine, and changing the height of the blade to control the resultant cut deep.

FIG. 9 shows the capacitance of graphene capacitive touch sensors measured after the coating of a PDMS protective layer at different spinning speeds.

FIG. 10 shows the change of sensor capacitance as a function of the touching pressure, using either conductive (Au/PDMS) or insulating (PDMS) probes. Graphene capacitive sensors show selectivity to the touching actuator composition.

FIG. 11 shows, schematically, (a) a top-view of the interdigitated capacitor (IDC) and cross-sectional views of an IDC unit cell (b) before and (c) after finger touching.

FIG. 12(a) is a schematic illustration of the experimental setup used to calibrate the pressure exerted on a commercial force meter model FS1500; inset: Labview screenshot taken during the calibration. FIG. 12(b) is a photograph of the experimental setup. FIG. 12(c) shows the force vs step length using different step size ranging between 0.001 and 0.01 mm.

FIG. 13 shows the capacitance change of graphene sensors as a function of the pressure exerted on the sensor active area. Comparison between sensors with different geometries of interdigitated electrodes, including vertical lines (red circle), squares (black squares), and horizontal lines (green triangles).

FIG. 14 shows the pressure sensitivity vs detection limit of graphene based sensors according to embodiments of the present invention compared to those reported in the literature.

FIG. 15 shows the ΔC/C₀ vs pressure of (a) flat and (b) bent graphene capacitive sensors according to embodiments of the present invention with a radius of curvature of 22 mm.

FIG. 16 shows the readout interface circuitry implemented in a flexible polyimide substrate and integrated at the back of a robotic hand according to an embodiment of the present invention.

FIG. 17 is a schematic of the readout interface circuitry of the robotic hand shown in FIG. 16.

FIG. 18 is a schematic diagram of a graphene touch sensor driven by a solar cell.

FIG. 19 shows Z and θ vs frequency of a graphene based capacitor as used in embodiments of the present invention.

### DETAILED DESCRIPTION

The manufacture of a sensor according to an embodiment of the invention will now be described.

Firstly the touch sensitive layer was fabricated by large area transfer of graphene on 125 μm thick flexible poly vinyl chloride (PVC) substrates. Large area chemical vapor deposited (CVD) graphene was transfer printed on flexible PVC substrates. First a 125 μm thick PVC pouch was laminated on the graphene side of 4 inch copper foils and left on the surface of FeCl₃ solution (1 M) for two hours to etch the copper completely. After the copper etching was complete, the graphene holding PVC samples were rinsed in deionized (DI) water and dried in flow N₂.

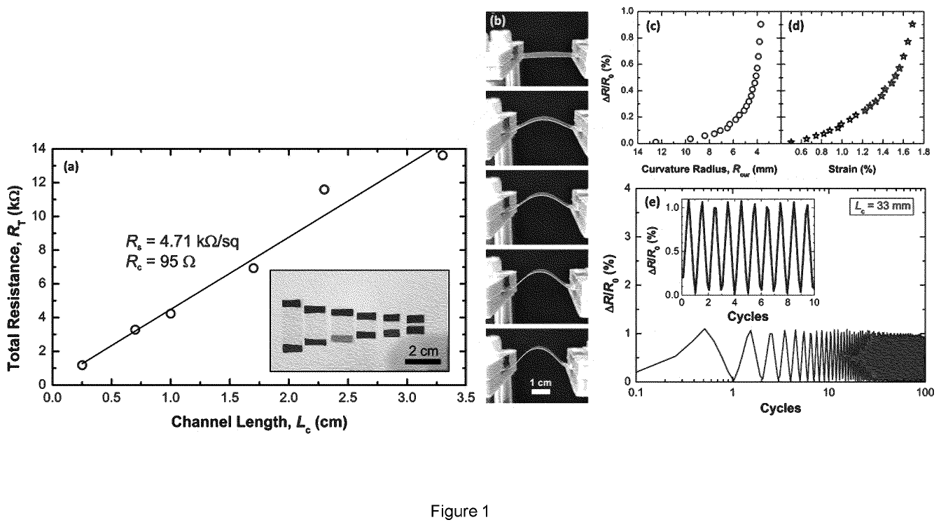

In the embodiment described, commercially available single layer CVD graphene was used for which the growth parameters and the characterization on rigid substrates has been previously demonstrated elsewhere [31, 32]. Some of the properties of graphene layers on flexible PVC substrates were analysed after transfer printing. Firstly, electrical properties of graphene were analyzed by transfer length method (TLM). Ti (10 nm)/Au (100 nm) electrodes were directly evaporated on the edges of the graphene-on-PVC samples in an electron beam (e-beam) evaporator with a background pressure of 10⁻⁵ Pa. Channels with a width of W_{c}=11 mm and lengths of L_{c}=2.5-33 mm were defined using a polymer shadow mask on graphene area. Both the sheet resistance (Rₛ) of graphene-on-PVC and contact resistance (R_{c}) between graphene and Ti/Au electrodes were measured by TLM. FIG. 1(a) shows the measured total resistance (R_{T}) of samples with different L_{c}; the figure represents the experimental data along with its best linear fitting. Using the slope (Rₛ/L_{c}) and the y-intercept (2R_{c}) of fitted line represented in FIG. 1(a), the values of Rₛ and R_{c} calculated from the total resistance formula, R_{T}=(Rₛ/W_{c})L_{c}+2R_{c}, were 4.71 kΩ/sq and 95Ω, respectively.

To analyze the electro-mechanical properties and cyclic stability of the graphene-on-PVC samples, applied mechanical stress was applied through a bending test and the resistance change recorded. Accordingly, the active bending test of the flexible graphene-on-PVC sample with a L_{c} of 33 mm was carried out taking snapshots while measuring R_{T} every 0.2 mm up to a step size of 4 mm. FIG. 1(b) shows a reduced sequence of snapshots, including steps size of 0, 1, 2, 3 and 4 mm (from top to the bottom of the figure). The resistance change (ΔR/R₀) as a function of both the radius of curvature (R_{cur}) and the strain are shown in FIG. 1(c) and FIG. 1(d), respectively. The latter was calculated by

$$Strain ( \% ) = \frac{F ( {t}_{s} + {t}_{f} )}{2 {R}_{c}} \qquad ( 1 )$$

(see [6, 33, 34]) where tₛ and t_{f} are the thickness of the substrate and the film (graphene), respectively, and F is a parameter that depends on both the thickness (t_{f}:tₛ) and Young's modulus (Y_{f}:Yₛ) ratios of the substrate and the film. Due to the two-dimensional nature of graphene, tₛ>>t_{f}, thus from (1) we can assume that F is approximately 1. From FIG. 1(c) one can deduce that ΔR/R₀ reaches a maximum value of around 0.92% when the graphene layer is bent up to R_{cur}=4 mm, which corresponds to a strain of around 1.7% (FIG. 1(d)).

To demonstrate the stability of the graphene films, a cyclic bending test was also performed with 100 cycles. FIG. 1(e) shows the results from this, observing ΔR/R₀ values lower than 1% along with the entire range which is a good indicator of the material stability under dynamic bending. The observed changes in resistance are believed to be mainly dominated by the change of R_{c} due to the crack formation at graphene-Au interface.

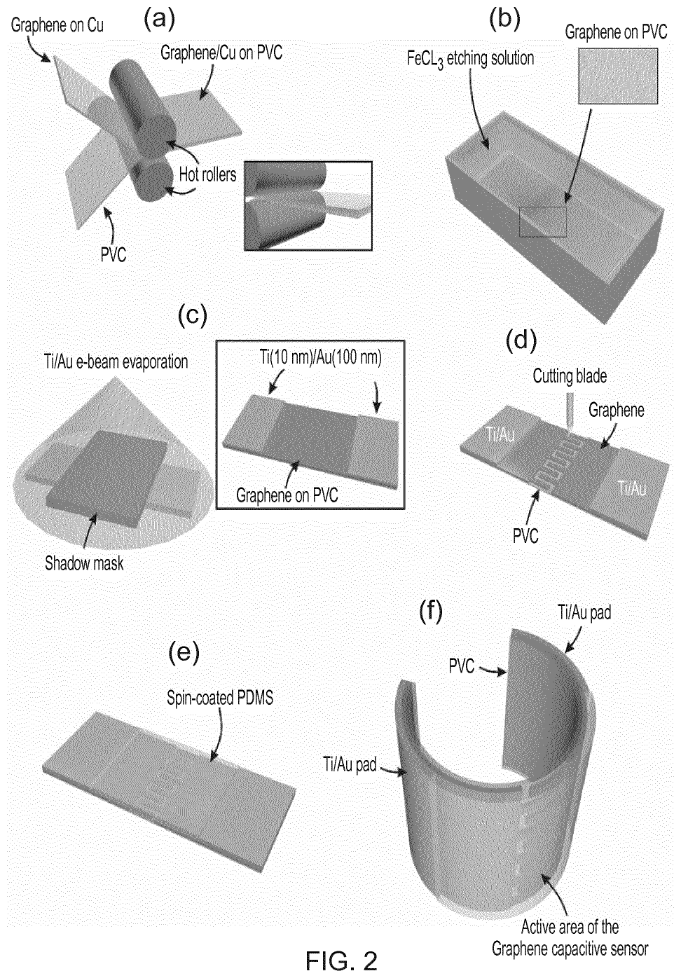

After the electro-mechanical characterisation of graphene-on-PVC samples, flexible capacitive touch sensors were fabricated from them. FIG. 2 summarizes the fabrication steps of graphene-based transparent and flexible capacitive touch sensors according to embodiments of the present invention.

FIG. 2(a) shows the use of a hot lamination method for transfer printing of CVD graphene onto 125 μm thick PVC substrates. At 110° C., the active side of the PVC sticks to the graphene holding Cu and makes a conformal contact to the Cu surface. Etching the Cu foil in FeCl₃ solution yields the graphene-on-PVC samples (FIG. 2(b)). Using e-beam evaporation and shadow mask, Ti/Au was deposited (10 nm/100 nm) on the edges of the sample to obtain electrical contact pads (FIG. 2(c)). After this, a computer controlled cutting machine, equipped with a plotter blade, is used to shape the single layer graphene as co-planar interdigitated electrodes (FIG. 2(d)). The cutting machine various patterns to be created without using complex lithographic and chemical procedures. Following the patterning step, 25 μm thick PDMS was spin-coated and cured on the graphene channel (FIG. 2(e)). The PDMS serves as the protective dielectric layer between external stimuli and graphene and also provides a good encapsulation of the device. FIG. 2(f) shows the resultant transparent and flexible touch/pressure sensor that can be integrated on a robotic hand.

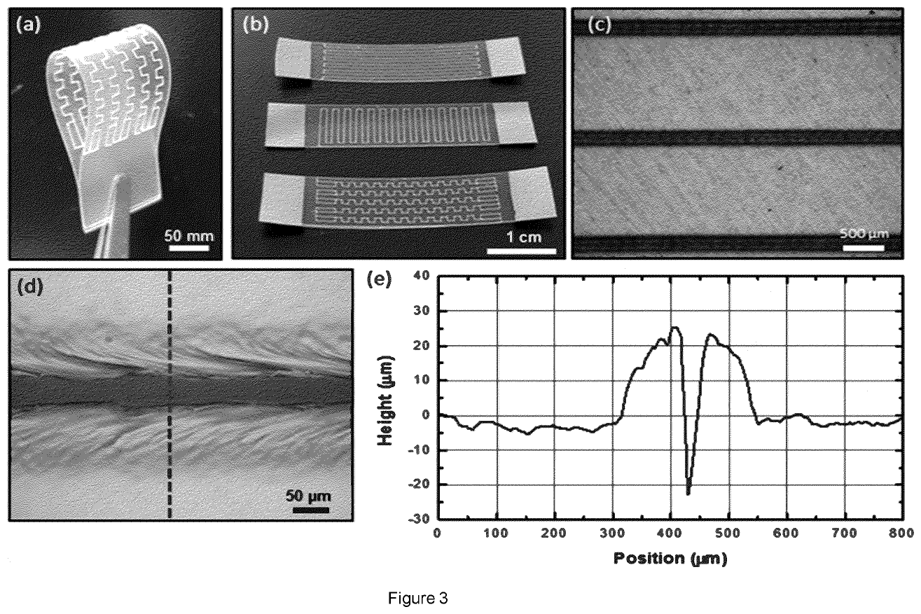

FIG. 3(a) shows the high flexibility of the fabricated graphene-on-PVC sample with an interdigitated pattern on it. FIG. 3(b) shows various flexible sensing devices according to embodiments of the present invention with Ti/Au electrical contact pads.

As shown in FIG. 2(d), by using a computer controlled cutting system sensors with different interdigitated designs on graphene (e.g. linear or meander) can be produced, which allows the electrode geometry to be tuned to improve the device sensitivity through the increase of the sensor active area.

FIG. 3(c) shows an optical microscope image of the cuts on graphene-on-PVC sample. The depth of the cut can be arranged for various substrate thickness by using the software as illustrated in FIG. 8 and described in more detail below.

FIG. 3(d) shows a magnified optical microscope image and the dashed line indicates the scanning direction of stylus profiler. In the sample shown, ˜25 μm deep cutting was performed on 125 μm thick PVC substrates to isolate graphene layers without compromising the overall mechanical robustness of the structure (see FIG. 3(e)). The cutting process also creates a stress on the flexible substrates, which results in ˜20 μm thick material accumulation on the edges of the cuts. Since fabricated sensors are based on large area graphene electrodes, the resulting material accumulation at the edges of the defined gap has negligible effects on the mechanical properties and performance of sensors.

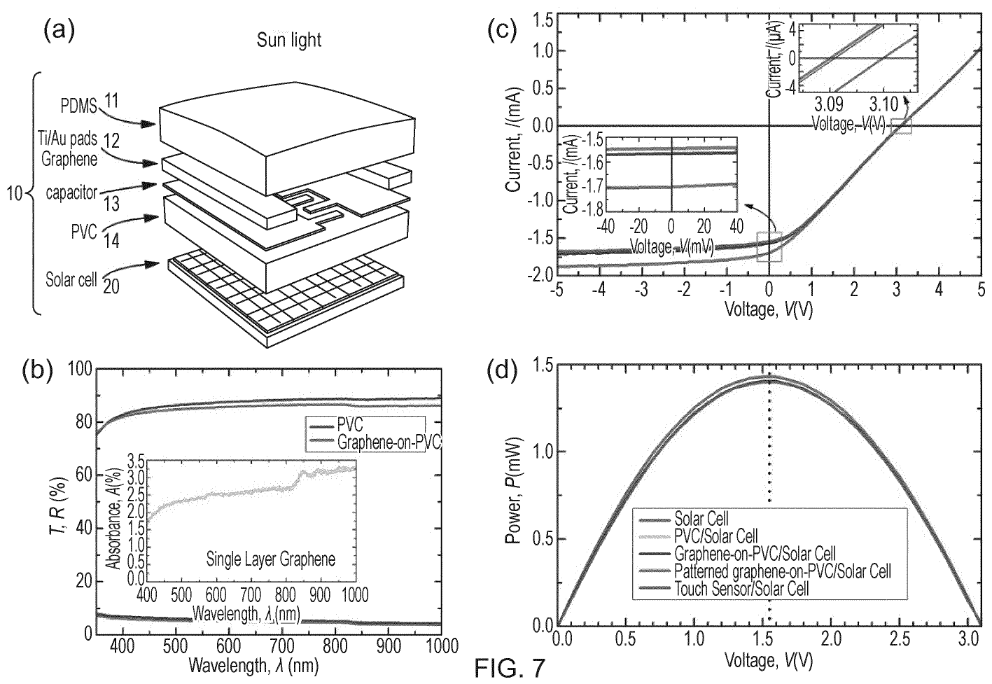

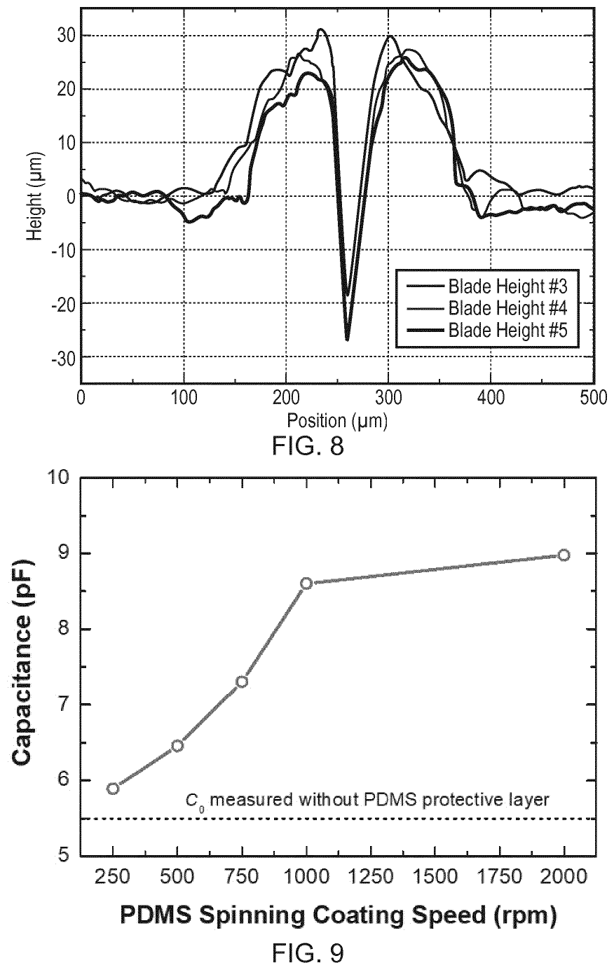

After the fabrication of graphene based flexible capacitive touch sensors, their response under quasi-static touching conditions was tested. Using a Keysight (E4980AL) LCR meter, first the base capacitance (C₀) of sensors in air ambient conditions was measured and values in the range of ˜8-9 pF were obtained. C₀ was also measured before the deposition of the PDMS protection layer (further description of PDMS deposition is set out below), showing a value of 5.5 pF. This shows that the PDMS protective layer increases the sensor capacitance, which is largely due to the higher dielectric constant of PDMS with respect to the air (ε=3ε₀, ε₀ being the dielectric constant of the air). It was also noted that the thickness of PDMS strongly influences the C₀, i.e. thicker the PDMS, lower the C₀ (see FIG. 9).

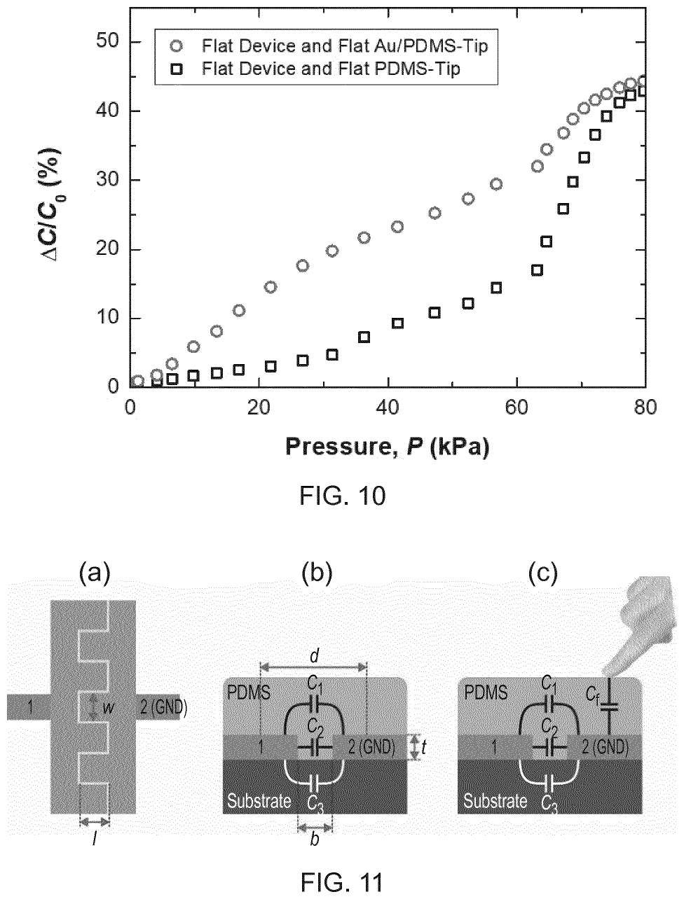

For the sake of comparison, the response of graphene capacitive sensors to touch was analysed using both conductive and insulating probes, consisting of 1 mm thick PDMS coated with 500 nm thick Au layer, and 1 mm thick PDMS without Au layer, respectively. Both conductive and insulating probes cause an increase in the capacitance of sensors with respect to C₀. Comparing both results (see FIG. 10), the conductive PDMS rubber is able to produce higher responses in the capacitance change (e.g. ΔC/C₀=25% at 40 kPa) than its insulating counterpart (e.g. ΔC/C₀=10% at 40 kPa). These results are mainly due to two main mechanisms: (1) the change of the PDMS protective layer thickness due to deformation, and (2) the existence of a third capacitance coming from the touching probe.

The first mechanism is observed in both experiments utilizing conductive and insulating PDMS rubbers and it is in good agreement with the variation of the sensor capacitance with PDMS thickness (see FIG. 9).

The second mechanism is only appreciable in the case of using a conductive PDMS rubber, playing the role of a third electrode that adds an additional capacitance to the total capacitance of the sensor (see FIG. 11). While the response obtained from conductive and insulator probes can be calibrated to read an accurate pressure independently on the probe, the demonstrated touch selectivity of the sensors increases e-skin functionality and would allow the spatial detection of objects with different compositions in contact with the e-skin.

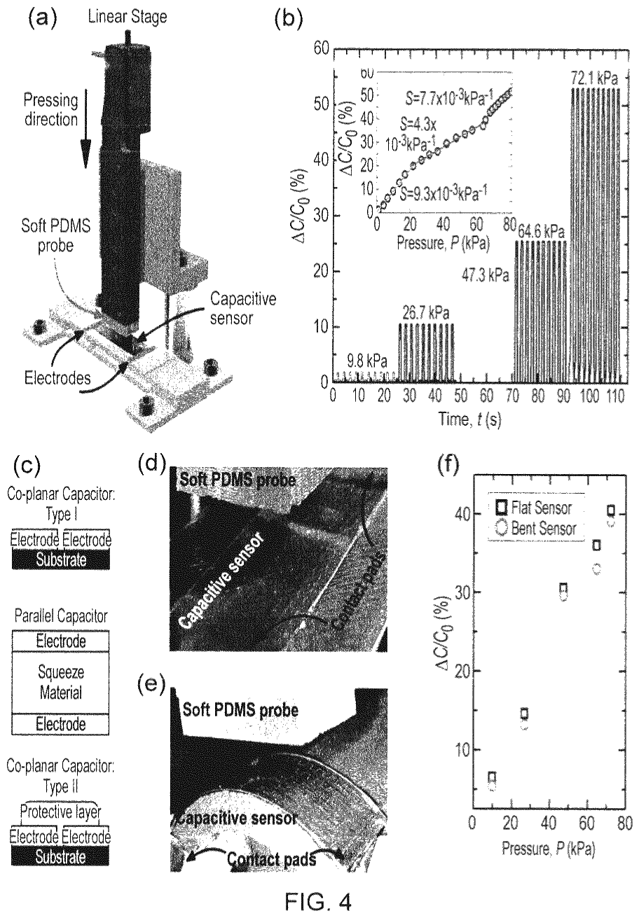

In order to analyse thoroughly this experimental evidence, quasi-static touching experiments were carried out by using a linear stage motor to exert periodic pulses of pressure on the device active area using the apparatus shown in FIG. 4(a). As mentioned above, for gentle touching the described insulating PDMS rubber was attached to the stage. Using Labview software, the linear stage movement was configured to perform quasi-static touching experiments, consisting of squared shape pulses of pressure with a frequency of 2 Hz.

FIG. 4(b) shows the capacitive response (ΔC/C₀) measured over time on graphene based flexible capacitive touch sensors according to embodiments of the present invention. The high accuracy of the linear stage motor enabled the PDMS rubber to be moved down to micrometric distances and allowed periodic pressures of different magnitudes to be exerted on the sensors. Controlled external pressures were exerted on the sensors over time, and the capacitance change simultaneously recorded with the LCR meter as shown in FIG. 4(b).

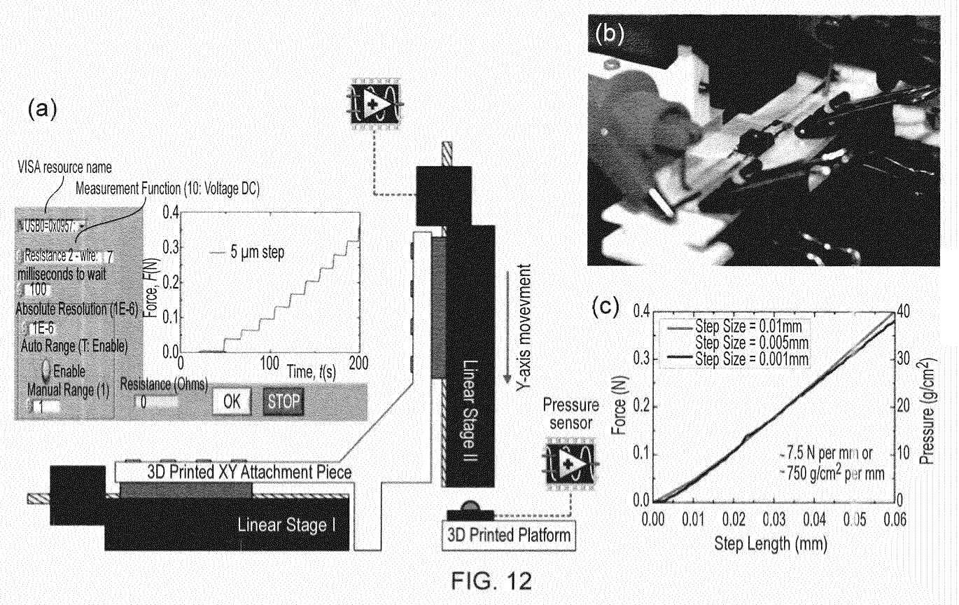

Firstly, the pressure exerted on sensors was calibrated as a function of the linear stage step length using a commercial force meter (see FIG. 12). FIG. 4(b) shows a collection of five different measurements consisting of 10 periodic touching cycles (frequency of 0.42 Hz) carried out at different pressures ranging between 9.8 and 72.1 kPa. All sensors based on interdigitated electrodes with different geometries including lines and meandered shapes (e.g. as illustrated in FIG. 3(b)) were analysed.

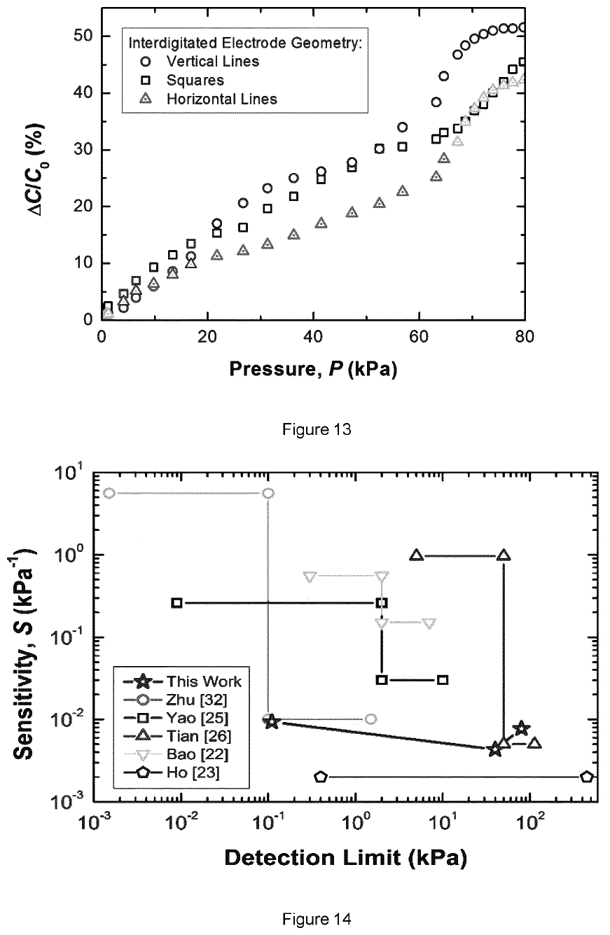

Among various geometries, the meandered shaped interdigitated electrodes shown in FIG. 3(a) provided one of the highest capacitance modulation and uniform response along with the scanned pressure range as shown in FIG. 13. Following these findings, the response of this specific sensor sample was further analysed.

This capacitive sensor shows stable response for all the analysed pressures, i.e. pressures of 9.8, 26.7, 47.3, 64.6 and 72.4 kPa resulting in ΔC/C₀ 1.9%, 10.5%, 17.3%, 25.5%, and 53.1%, respectively. More importantly, ΔC/C₀ presents different values depending on the applied pressure. This pressure sensitivity is a new and potentially useful behaviour in co-planar based structure, especially because the conventional co-planar or staggered structures (such as the co-planar capacitor type I shown in FIG. 4(c)) commonly used in commercial capacitive touch screens can only sense presence or absence of touch.

Another common approach reported for graphene capacitive sensors, is the use of graphene as two conductive parallel electrodes separated with a stretchable material (such as the parallel capacitor shown in FIG. 4(c) and described in [17, 18]). In this approach, the graphene directly experiences the pressure, which may damage the graphene and may lead to reliability issues. In the co-planar structure presented here (as illustrated by the co-planar capacitor type II FIG. 4(c)), the pressure exerted on the PDMS protective layer does not affect the spacing between electrodes. Thus, it is believed that the variation of the capacitance with the applied pressure is mainly due to the change of the PDMS thickness as was demonstrated by depositing PDMS layers with various thickness on top of the active area of the device (see FIG. 9).

The sensitivity of the sensor was calculated by S=δ(ΔC/C₀)/δP, where P is the applied pressure. S depends on the applied pressure range, as shown in the inset of FIG. 4(b). From 0 to 20 kPa, sensors present a sensitivity of 9.3×10⁻³ kPa⁻¹, between 20 and 60 kPa they show 4.3×10⁻³ kPa⁻¹, and at pressures higher than 60 kPa sensors present a sensitivity of 7.7×10⁻³ kPa⁻¹.

Capacitive sensors according to embodiments of the present invention show an S lower than those obtained in capacitive sensors based on conductive porous sponges that show up to 0.26 kPa⁻¹ in the range of pressure below 2 kPa. In contrast, sensors according to embodiments of the present invention show similar sensitivities along with a wider range of pressures up to 80 kPa, and have attractive properties such as transparency, thin structure, and sensitivity to the pressure, which are all useful features for e-skin applications.

In addition, the sensors according to embodiments of the present invention show a unique behaviour that has not been observed before, which is the second increase of the sensitivity above 60 kPa. That behaviour makes this device even more useful across a broad range of pressures, where other reported pressure sensors show loss of sensitivity with pressure (see FIG. 14 and Table 1).

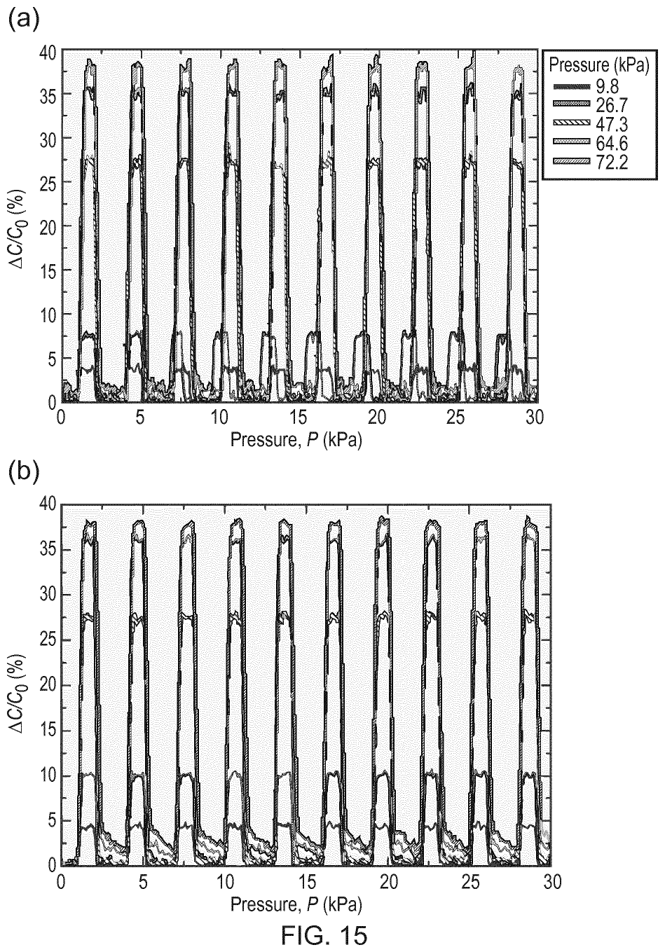

In order to evaluate the functionality of the graphene capacitive touch sensors, especially when they are integrated non-planar surfaces, the measured response of sensors on both flat surfaces (as illustrated in FIG. 4(d)) and non-planar surfaces (as illustrated in FIG. 4(e)) was compared. Quasi-static measurements of ΔC/C₀ were carried out in flat and bending mode, using flat and bent PDMS soft probes to touch the same active area in both scenarios (see FIG. 15). FIG. 4(f) shows that the response, i.e. ΔC/C₀, of the sensors remains unaffected in both cases. This is mainly because of the intrinsic mechanical robustness of graphene, which preserves electrical properties after transfer to either flat or non-planar surfaces. In addition, the good conformal contact formed between graphene and PVC substrate during the hot lamination transfer procedure, makes the device architecture more robust and very stable even under the stresses experienced during bending.

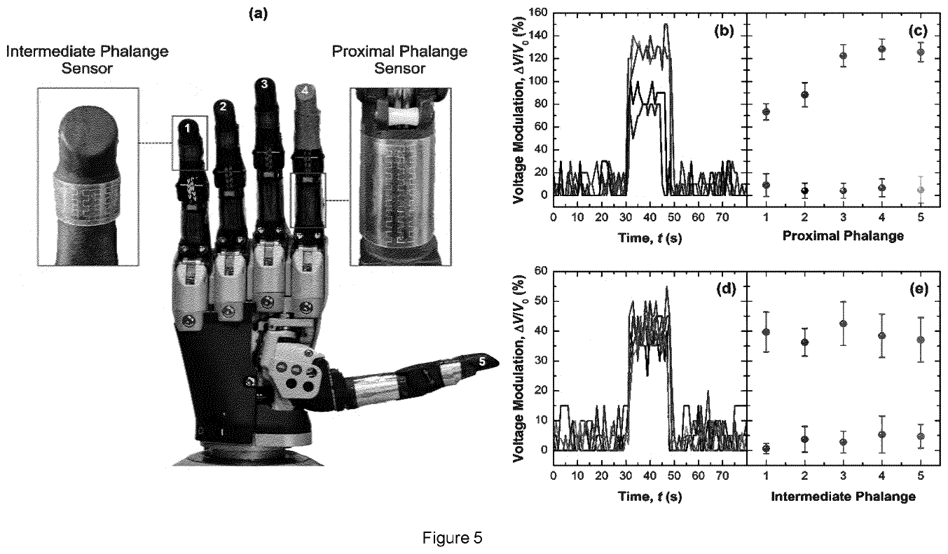

In order to check the validity of the graphene touch sensors according to embodiments of the present invention for e-skin, the sensors were integrated at the intermediate and proximal phalanges of i-Limb, a state-of-the-art bionic hand manufactured by Touch Bionics Inc of Mansfield Mass., US, as shown in FIG. 5(a). Due to the different size of the phalanges, sensors placed at intermediate phalanges have less active area than those placed at proximal phalanges.

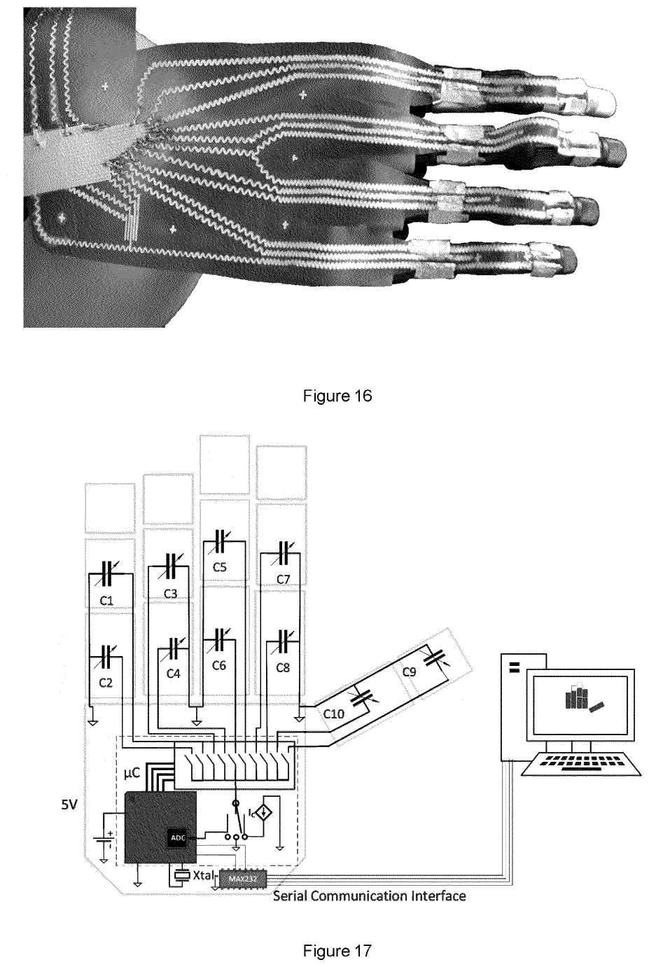

FIG. 5(a) shows a magnified image of sensors on each phalange, with clearly visible IDC electrodes. The response of graphene sensors was converted from capacitive variation to a voltage through a readout interface circuitry which was designed and implemented in a flexible polyimide substrate with the results shown in FIG. 16. The printed circuit had option to read ten sensors from the intermediate and proximal phalanges of five fingers of i-Limb. A further description of the circuit and interface for capacitive sensing is shown in FIG. 17. In order to measure the capacitances, the charge in the capacitor is discharged completely and then a constant current (I_{C}) of 55 μA was pumped into each of the sensor through a switching interface for a fixed time Δt (100 ms). The output voltages (V) from each sensor was read through the switching interface and a 10 bit analog-to-digital convertor (ADC) interface of a microchip PIC (18F4X) microcontroller. The change in the output voltage because of the constant current pumped into the capacitive sensors is given by ΔV. Since, I_{C} is pumped here for a small time, by measuring the change in the voltage, the capacitance can be calculated by

$$C = {{I}_{C} ( \frac{Δ V}{Δ t} )}^{- 1} \qquad ( 2 )$$

Before measuring the capacitance, the voltage at each sensor was set to 0 V. The value of base voltage depends on the capacitance (which is sensitive to the sensor size). Any change in capacitance will result in further modulation in the charged voltage compared to the base voltage which is denoted as ΔV/V₀, which is plotted for sensors on various phalanges in FIGS. 5(b) and (d) with respect to time of touch operation with a gloved hand. The charge time measurement is carried out sequentially for all the capacitive sensors by switching the channel shown in FIG. 17 through the microcontroller. The data was acquired and sent to a PC serially where a Labview interface was implemented for further processing, display and analysis.

The ΔV/V₀ for proximal and intermediate phalanges are shown in FIGS. 5(c) and (e), respectively. For proximal phalanges, the tactile input through a gloved hand caused a change in capacitance of 60 to 140%, whereas for intermediate phalanges the change was from 30 to 50% (in both cases including the experimental error). The differences arise mainly because of the active area of intermediate phalanges sensors is smaller (8×11 mm²) than proximal phalanges for all the fingers (the proximal sensors at heart (#3), index (#4), and thumb (#5) fingers have a size of 7×20 mm², whereas at little (#1) and ring (#2) fingers they have a size of 7×15 mm²). It is worth noticing that the small difference in the active area of sensors is still detectable within proximal phalanges, observing higher modulation in proximal phalanges #3, #4 and #5, than proximal phalanges #1 and #2 (see FIG. 5(c)).

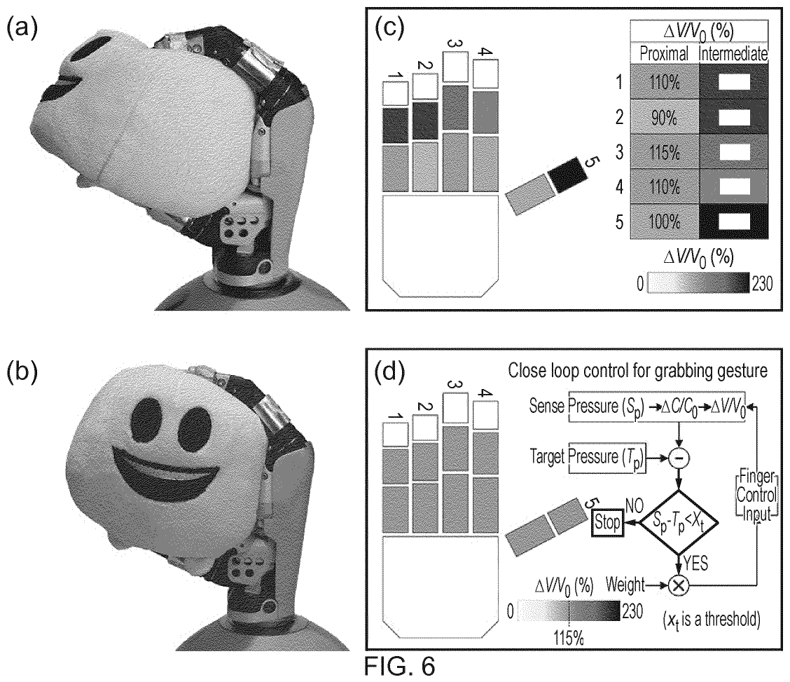

The viability of graphene-based skin sensors was also analysed by means of a dynamic characterization consisting in the grabbing of a soft object as shown in FIG. 6(a). In this scenario, the readout interface circuitry allows the response of all sensors in contact with the object to be measured. Depending on the sensor active area covered with the object, different changes of the readout voltages were measured at each sensor.

FIG. 6(c) shows a colour map of the resultant grabbing experiment, showing variations between each sensor placed at different phalanges. Due to the morphology of the soft object used, the sensors at intermediate phalanges show higher ΔV/V₀ (up to 233% in the case of the thumb) than those obtained in the proximal ones. In addition, the ΔC/C₀ of each sensor during the grabbing of the soft ball was measured with the tactile feedback disabled (i.e. under the conditions of FIGS. 6(a) and (c)) to demonstrate the sensitivity of the sensors. Values of ΔC/C₀ above 60% were observed, which correspond to a sensitivity of the sensor of 7.7 Pa⁻¹ for pressures above 60 kPa. In this case, the increase of the touch sensor sensitivity at high pressures is beneficial for the accurate response of the robotic motion in a wide range of pressures. This experiment provides good evidence of the touch/pressure detection capability of graphene sensors according to embodiments of the present invention under the routine bending situation, and a demonstration of potential application of such sensors in robotics and prosthetics.

In order to further exploit the potential of these sensors, a closed-loop system for use of the sensors to control the motion of the robotic hand has also been developed. FIG. 6(a) and FIG. 6(b) show the grab of a soft object having the tactile feedback disabled and enabled, respectively. From a visual comparison of the two figures it can be seen that the latter shows a gentler grabbing of the soft object. This was made possible because the movement of the hand was programmed and controlled by the closed-loop system in such a way that sensors placed at the phalanges received a maximum ΔV/V₀ of 115% as represented in FIG. 6(d).

Following the logic diagram presented in the inset of FIG. 6(d), it can be seen that that the grabbing motion of each finger is stopped when the ΔV/V₀ exceeds a threshold value (in this case 115%). In this regard, sense pressure (Sₚ) of each finger is firstly measured through ΔC/C₀ (or ΔV/V₀) through the described sensor calibration (FIG. 4(e)). Thereafter, the difference between Sₚ and the target pressure (Tₚ), i.e. Sₚ-Tₚ, is compared with a threshold value (xₜ). On one hand, a negative result stops the finger grabbing, indicating that the finger is applying the desirable pressure. On the other hand, if a positive result is obtained, first the resultant difference is weighted by a compliance parameter, then, the finger control input will move the finger according to the difference between the Sₚ and Tₚ. For example, at the beginning, fingers will grab the object very fast due to the high difference between Sₚ and Tₚ. In contrast, the finger grabbing will become slow when the difference between Sₚ and Tₚ is reduced, i.e. the object is almost grabbed using the desirable pressure.

The above description and accompanying figures demonstrate that the integration of transparent touch/pressure sensors according to embodiments of the present invention with CMOS technology can make the grabbing of robotic fingers more accurate by mimicking human grabbing features.

All of the layers used in the touch sensors according to embodiments of the present invention, including the protective layer (PDMS), the capacitive layer (graphene), and the flexible substrate (PVC) are transparent. This transparency allows the graphene touch sensors to be integrated directly on top of solar cells. The effective integration of both technologies could allow charging of batteries to run either the motors for robotic hand movements or the readout circuitry of the sensors as discussed below; this may lead to self-powered robotics/prosthetic limbs with tactile sensitivity.

To test this, a heterogeneous layered tactile skin stack was manufactured comprising photovoltaics in the back plane covered with a transparent e-skin layer based on graphene touch sensors according to embodiments of the present invention. This is schematically illustrated in FIG. 7(a), where a transparent touch capacitive sensor 10 is directly placed atop a solar cell 20. The transparent touch sensor consists of a PDMS protective layer 11 on top of single layer graphene-based co-planar interdigitated electrodes 12 as described in more detail above, with Ti/Au pads 13, all atop a flexible PVC substrate 14.

Due to the intrinsic transparency of all layers existing in the sensor, incident light is expected to be efficiently transmitted through the whole structure (as shown in FIG. 7(a)) reaching the surface of the solar cell. Indeed, it is also possible for the substrate 14 to be transparent.

In order to demonstrate the viability of such a configuration, the optical transmission of graphene based touch sensors such as those described in the embodiments above were analysed. FIG. 7(b) shows the transmittance (T) and reflectance (R) measurements of graphene-on-PVC and 125 μm thick PVC as a reference substrate. The measurements were carried out using conventional spectrophotometer (Shimadzu-2600 UV-VIS Spectrophotometer). As the reference sample, a PVC substrate was laminated without graphene. As shown in FIG. 7(b), graphene-on-PVC shows a change in the T and R with respect to the PVC reference sample ranging between 0.75-2.75%, and 0.3-0.5%, respectively, going from 350 to 1000 nm wavelengths. This deviation is associated to the substrate effect during both transmittance and reflectance measurements throughout the broad wavelength range. The absorbance (A) of the single layer graphene, removing the contribution from the PVC substrate, was calculated using the Beer-Lambert Law, i.e. A=log₁₀ (1/T); the resulting in A ranged between 1.75 and 3.25% at wavelengths between 400 and 1000 nm. The theoretical absorbance in the visible range of free-standing graphene is estimated around 2.3% [15]; graphene samples studied in this work show A around 2.25-2.50% at wavelengths ranged between 390 and 700 nm (visible spectrum).

To demonstrate further the transmittance of the structure in FIG. 7(a), a low-cost amorphous Si (a-Si) based solar cell (Sanyo Company), with an effective area of 39.6×22.9 mm² was used as the base for integration of a sensor according to an embodiment of the present invention. The current-voltage (I-V) characteristics of this solar cell were measured after the integration of different layers on top of its surface, namely a graphene-on-PVC, patterned graphene-on-PVC, and patterned graphene-on-PVC encapsulated with PDMS. FIG. 7(c) summarizes the I-V characteristics obtained from each sample. The open circuit voltage (V_{oc}) and short circuit current (I_{sc}) of the solar cell were estimated from the interception of the curve with x-axis and y-axis, respectively, as clearly observed in the inset of FIG. 7(c).

It was observed that, as expected, both V_{oc} and I_{sc} parameters decrease after the addition of a layer on top of the solar cell surface, which means the graphene touch sensor is absorbing/reflecting partially the incident light. Some light may get scattered as well within the graphene touch sensor and interface before reaching the solar cell. From the power-voltage (P-V) characteristics of the solar cell (FIG. 7(d)), a maximum power of around 1.48 mW with a maximum voltage (Vₚₘₐₓ) of 1.55 V and maximum current (Iₚₘₐₓ) of −0.95 mA is observed.

The integration of touch sensor atop the solar cell could change the solar cell absorption performance. In order to analyse this effect, the fill factor (FF) of the solar cell before and after integration of graphene touch sensors atop the solar cell surface was analysed. Prior to the graphene touch sensor integration, the FF of the solar cell was 0.281 as calculated by

$$FF = \frac{{I}_{pmax} {V}_{pmax}}{{I}_{sc} {V}_{oc}} \qquad ( 3 )$$

The integration of the graphene capacitive touch sensor atop the solar cell was found to cause a decrease of the FF of around 8%.

The solar cell referred to above is able to produce a power of 160 mW/cm² and is fairly typical of such low-cost solar cells. Accordingly, if a tactile skin as shown in FIG. 7(a) were to cover the glabrous skin of a human hand (average area around 120 cm²), the solar cells used would generate 1.92 mW, which is sufficient to drive the tactile skin and its readout circuits, as discussed below.

However, with a solar cell having better performance than the one used in the above analysis, much higher net powers can be generated. For example, for the same hand area, a solar cell based on polycrystalline-Si (16.6 W/cm², Sanyo), crystalline-Si (30 W/cm², Panasonic), GaAs (33.3 W/cm², Alta devices), and multi-junction structures (45.6 W/cm², Spectrolab) we can obtain net powers of 1.99, 3.71, 4.05, and 5.47 W, respectively. The higher net power could be either be stored for later use (e.g. in lower-light environments) or used to drive the actuators of robotic hand.

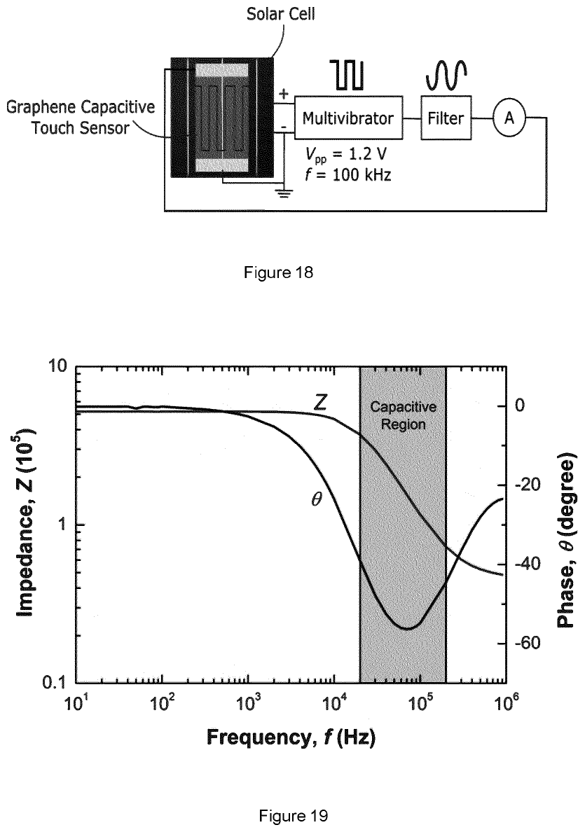

In order to demonstrate the viability of our approach, a DC to AC circuit (FIG. 18) was designed to transform the DC signal generated by 3 PV cells connected in parallel (output voltage: 2.6 V, output current: 0.78 mA) into an AC signal (Vₚₚ=1.2 V and f=100 kHz). This was applied to the capacitive touch sensor module integrated on top of the PV cell. The frequency of the AC signal was chosen according to the capacitive region of the graphene touch sensors using impedance measurements (see FIG. 19). The designed circuit consumes a power of around 0.36 mW, which can be driven by the energy generated from PV cells (2.03 mVV).

With the generated AC signal applied to the touch sensor, the measured current before and during touching was 138 and 240 nA, respectively. This means the current increases due to the increase of the sensor capacitance around 10 pF during touching. The sensor consumes only 31 and 55 nW energy before and during the touching respectively, which confirms the low-power consumption of the capacitive touch sensors presented according to embodiments of the present invention.

The effect of the blocking of light during touching on the solar cell energy generation was also analysed by measuring the amplitude and frequency of the AC signal using an oscilloscope and it was observed to have a low effect on the resulting output. Accordingly, touch sensors according to embodiments of the present invention allow fabrication of energy autonomous tactile skin by harvesting daylight energy to power up either DC to AC IC, capacitance-to-voltage IC or the robotic hand motion. This approach can be further exploited by integrating flexible touch sensors according to embodiments of the present invention on flexible and stretchable solar cells, enabling a new concept of energy autonomous robotics and prosthesis.

Further embodiments of the present invention provide touch-sensors, such as those described above, integrated with solar cells, preferably flexible and stretchable solar cells.

Supplementary Materials

In fabricating the touch sensors according to the above embodiments, a Silhouette CAMEO® electronic cutting tool was used that has a cutting force of 210 gf and includes a blade that can extend to approximately 1 mm in depth to accommodate thicker material types. The depth of the cut can be arranged for various substrate thickness by using the Silhouette Studio software. As firstly shown in FIG. 8 and summarized in the Table 1 below, the use of different blade heights (it is an adjustable parameter in the system) allows different cutting depths from 18.2 to 26.3 μm to be defined. The blade has 10 different adjustable heights, and the software enables to choose different kind of papers, therefore, if need it, the range of cutting deeps can be further extended.

TABLE 1
Blade cutting depth vs blade height

| Blade | Depth of the |
|---|---|
| Height no. | Cut (μm) |
| 3 | 18.2 |
| 4 | 23.4 |
| 5 | 26.3 |

Influence of the PDMS Protective Layer Thickness on the Capacitive Sensor Response

After the definition of the interdigitated patterns on graphene-on-PVC, a PDMS protective layer was deposited atop the active area of the sensor. Firstly, silicone elastomer and a curing agent were mixed with a mass ratio of 10:1. Thereafter, the liquid mixture was degassed for 30 min in a low vacuum chamber (0.1 Pa). The resultant PDMS was spin-coated on the sensor active area at different speeds ranging between 250 and 2000 rpm, and finally cured in an oven for 1 h at 70° C. The capacitance of the sensors with different PDMS protective layer thickness is shown in FIG. 9. The plot shows that the capacitance of the sensor is sensitive to changes in the thickness of the PDMS protective layer, presenting in all the cases higher capacitances than parasitic capacitance measured prior to the PDMS deposition (5.5 pF). It is thought that this is main contributing factor to making our the capacitive sensors according to embodiments of the invention sensitive to pressure.

Influence of the Touching Probe on the Capacitive Sensor Response

Conductive and insulating PDMS soft probes were used as the touching probes to study the response of the graphene sensors. PDMS was prepared using the same conditions described in the previous section. Then, the PDMS was cured in a 3D-printed mould taking the shape of desired probe. Finally, one of the probes was coated with 500 nm thick of Au using e-beam evaporation. The analysis of ΔC/C₀ obtained by using either conductive or insulator PDMS shows that the former causes higher modulation on the capacitance than the latter (FIG. 10). It is assumed that this is because of the direct contact of conductive PDMS with sensor's active area, which adds an extra capacitance and changes the overall capacitance of the device. In this regard, these sensors are able to distinguish between conductive and insulator materials.

Basics of a Capacitive Touch Sensor

The total capacitance of an interdigitated capacitor (IDC), i.e. C_{IDC}, such as that represented in FIG. 11(a), can be obtained by [D. Sinar et. al, Proc. 14^{th} IEEE Int. Conf. Nanotech. Toronto, Canada, 2014]

C_{IDC}=C_{Ucell}(n−1)l (4)

Where l is the length of the electrodes, (n−1) is the number of unit cells, and C_{Ucell} is the capacitance of each unit cell, and consists in the summation of individual co-planar capacitances over the entire cell

C_{UCell}=C₁+C₂+C₃ (5)

Where C₁, C₂, and C₃ are the individual capacitances represented in FIG. 11(b), and can be calculated as

$${C}_{1} + {C}_{3} = {ɛ}_{0} ( \frac{{ɛ}_{PDMS} + {ɛ}_{s}}{2} ) \frac{K [ \sqrt{1 - {( \frac{d}{b} )}^{2}} ]}{K [ \frac{d}{b} ]} \\ {C}_{2} = {ɛ}_{0} {ɛ}_{PDMS} \frac{t}{d} \qquad ( 6 )$$

K[x] being calculated by using complete elliptic integral of the first kind because it provides a good model for the magnetic field; ε₀, ε_{PDMS} and ε_{PVC} being the electrical permittivity of the vacuum (8.885 pF/m), PDMS (2.3ε₀) and PVC substrate (3.0ε₀), respectively. As shown in FIG. 11(b), d is the distance between electrodes, t is the thickness of the electrodes, and b is the centre-to-centre electrodes distance of a unit cell, which depends on both the electrode width (w) and d. From expressions (4-6), one can deduce that the larger the area of the plates, the larger is the capacitance, as well as, the smaller the distance between the two plates, the higher is the capacitance.

As illustrated in FIG. 11(c), when a conductive object such as a human finger touches the active area of the capacitive sensor, an additional capacitor is formed with a capacitance of C_{f}, increasing the measured capacitance. In the case of touching the sensor with an insulator material, the change in the capacitance has the origin in the change of the dielectric constant of the surrounding medium as previously explained in sections B and C.

Calibration of the Applied Pressure During Touching Experiments

The accurate measurement of the pressure exerted on the graphene capacitive touch sensors was carried out with a commercial FS1500 force meter. The experimental setup consists of two linear stages attached by using a 3D printed piece, allowing micrometric motion of the touching probe along with the x-y plane (FIG. 12(a)). A Labview code was developed to measure the force experienced by the force meter as a function of the linear stage II step length (inset of FIG. 12(a)). FIG. 12(b) shows a photograph of the resultant experimental setup. Using three different steps size, comprising 0.01, 0.005 and 0.0001 mm, it was observed that the forces exerted by the linear stage II on the force meter is almost independent of the step size. This calibration was used to estimate the pressure applied on the active area of the graphene capacitive touch sensors (FIG. 12(c)).

Energy Autonomous Transparent Tactile Skin

A graphene capacitive touch sensor is integrated on top of a PV panel as shown in FIG. 18. Under ordinary daylight, the a-Si based PV cell from Sanyo generates a DC signal of V_{PV}=2.5 V and an I_{PV}=780 μA (P_{PV}=2.03 mW). The DC signal is converted into a AC signal using a low-power multivibrator (HCF4047BE), which was configured in order to generate a AC signal of Vₚₚ=1.2 V and f=100 kHz. The characteristics of the AC signal were chosen according to the capacitive behaviour of the sensor at frequencies around 100 kHz (see FIG. 19). The output signal consists of a square wave which was transformed into a sinusoidal wave using a RC filter. The resulting AC signal is applied to the graphene capacitive touch sensor as shown in FIG. 18. Sensor current was analysed before and during tactile touching, observing an increase of the current from 138 to 240 nA, respectively, which can be explained due to the increase of the sensor capacitance from 10 (before touching) to 20 pF (during touching).

Pressure Sensitivity and Detection Limit: Comparison with Known Sensors

Pressure sensors according to embodiments of the present invention are based on co-planar interdigitated electrodes of single layer graphene. Table 2 summarizes some of the most relevant works reported in the literature about pressure sensors and details the characteristics of the sensors, as well as their sensitivity and detection limits, i.e. range of pressure and minimum detectable pressure. For the sake of clarity, FIG. 14 represents the pressure sensitivity of sensors as a function of the detection limit.

TABLE 2
Characteristics of pressure sensors.

| | Embodiments | | | | | |
|---|---|---|---|---|---|---|
| | described above | Bao [19] | Ho [20] | Yao [22] | Zhu [29] | Tian [23] |
| Material | Single layer | Structured | Graphene | Graphene | Reduced | Laser scribed |
| | graphene | PDMS | | nano-sheets | graphene | graphene |
| | | | | | oxide | |
| Structure | Co-planar | Parallel | Parallel | Conductive | Microstructure | Foam like |
| | interdigitated | electrodes | electrodes | sponge | polymer | structure |
| | electrodes | | | | | |
| Sensor Type | Capacitive | Capacitive | Capacitive | Piezoresistive | Piezoresistive | Piezoresistive |
| Sensitivity (Pa⁻¹) | 4.3 | 550 | 2 | 260 | 5500 | 960 |
| Pressure range (kPa) | <80 | <2 | <500 | <2 | <0.1 | <50 |
| Min pressure (kPa) | 0.11 | 3 | 0.5 | 9 | 1.5 | 5000 |

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

In particular, although the methods of the above embodiments have been described as being implemented on the systems of the embodiments described, the methods and systems of the present invention need not be implemented in conjunction with each other, but can be implemented on alternative systems or using alternative methods respectively.

### REFERENCES

1 Yogeswaran, N. et al. New materials and advances in making electronic skin for interactive robots. Advanced Robotics 29, 1359-1373 (2015).
2 Tee, B. C. K., Wang, C., Allen, R. & Bao, Z. N. An electrically and mechanically self-healing composite with pressure- and flexion-sensitive properties for electronic skin applications. Nature Nanotechnology 7, 825-832, doi:10.1038/Nnano.2012.192 (2012).
3 Bauer, S. Flexible electronics: Sophisticated skin. Nature materials 12, 871-872 (2013).
4 Wang, C. et al. User-interactive electronic skin for instantaneous pressure visualization. Nature materials 12, 899-904 (2013).
5 Boland, J. J. Flexible electronics: Within touch of artificial skin. Nature materials 9, 790-792 (2010).
6 Dahiya, R. S., Mittendorfer, P., Valle, M., Cheng, G. & Lumelsky, V. J. Directions toward effective utilization of tactile skin: A review. Sensors Journal, IEEE 13, 4121-4138 (2013).
7 Dahiya, R. S., Metta, G., Valle, M. & Sandini, G. Tactile Sensing—From Humans to Humanoids. IEEE Transactions on Robotics 26, 1-20, doi:10.1109/TRO.2009.2033627 (2010).
8 Dahiya, R., Navaraj, W., Khan, S. & Polat, E. O. in Information Display Vol. 31 6-10 (2015).
9 Lipomi, D. J., Tee, B. C. K., Vosgueritchian, M. & Bao, Z. Stretchable organic solar cells. Advanced Materials 23, 1771-1775 (2011).
10 Wei, Y. J., Wang, B. L., Wu, J. T., Yang, R. G. & Dunn, M. L. Bending Rigidity and Gaussian Bending Stiffness of Single-Layered Graphene. Nano Letters 13, 26-30, doi:10.1021/n1303168w (2013).
11 Rybin, M. G., Pozharov, A. S. & Obraztsova, E. D. Control of number of graphene layers grown by chemical vapor deposition. physica status solidi (c) 7, 2785-2788, doi:10.1002/pssc.201000241 (2010).
12 Stankovich, S. et al. Graphene-based composite materials. Nature 442, 282-286, doi:http://www.nature.com/nature/iournal/v442/n7100/suppinfo/nature04969 S1.html (2006).
13 Wang, X., Zhi, L. J. & Mullen, K. Transparent, conductive graphene electrodes for dye-sensitized solar cells. Nano Letters 8, 323-327, doi:10.1021/n1072838r (2008).
14 Li, X. S. et al. Transfer of Large-Area Graphene Films for High-Performance Transparent Conductive Electrodes. Nano Letters 9, 4359-4363, doi:10.1021/n1902623y (2009).
15 Polat, E. O. et al. Synthesis of Large Area Graphene for High Performance in Flexible Optoelectronic Devices. Scientific reports 5 (2015).
16 Lee, M. S. et al. High-Performance, Transparent, and Stretchable Electrodes Using Graphene-Metal Nanowire Hybrid Structures. Nano Letters 13, 2814-2821, doi:10.1021/n1401070p (2013).
17 Chen, Y.-M. et al. Ultra-large suspended graphene as a highly elastic membrane for capacitive pressure sensors. Nanoscale 8, 3555-3564, doi:10.1039/C5NR08668J (2016).
18 Metzger, C. et al. Flexible-foam-based capacitive sensor arrays for object detection at low cost. Applied Physics Letters 92, 013506, doi:doi:http://dx.doi.orq/10.1063/1.2830815 (2008).
19 Mannsfeld, S. C. B. et al. Highly sensitive flexible pressure sensors with microstructured rubber dielectric layers. Nature Materials 9, 859-864, doi:10.1038/nmat2834 (2010).
20 Ho, D. H. et al. Stretchable and Multimodal All Graphene Electronic Skin. Advanced Materials 28, 2601-2608, doi:10.1002/adma.201505739 (2016).
21 Shirinov, A. & Schomburg, W. Pressure sensor from a PVDF film. Sensors and Actuators A: Physical 142, 48-55 (2008).
22 Yao, H. B. et al. A Flexible and Highly Pressure-Sensitive Graphene-Polyurethane Sponge Based on Fractured Microstructure Design. Advanced Materials 25, 6692-6698, doi:10.1002/adma.201303041 (2013).
23 Tian, H. et al. A Graphene-Based Resistive Pressure Sensor with Record-High Sensitivity in a Wide Pressure Range. Scientific Reports 5, 8603, doi:10.1038/srep08603 http://www.nature.com/articles/srep08603#supplementary-information (2015).
24 Mosser, V., Suski, J., Goss, J. & Obermeier, E. Piezoresistive Pressure Sensors Based on Polycrystalline Silicon. Sensor Actuat a-Phys 28, 113-132, doi:Doi 10.1016/0924-4247(91)85020-O (1991).
25 Samaun, Wise, K. D. & Angell, J. B. An IC Piezoresistive Pressure Sensor for Biomedical Instrumentation. IEEE Transactions on Biomedical Engineering Bm20, 101-109, doi:Doi 10.1109/Tbme.1973.324170 (1973).
26 Schwartz, G. et al. Flexible polymer transistors with high pressure sensitivity for application in electronic skin and health monitoring. Nature Communications 4, doi:ARTN 1859 10.1038/ncomms2832 (2013).
27 Takei, K. et al. Nanowire active-matrix circuitry for low-voltage macroscale artificial skin. Nat Mater 9, 821-826, doi:10.1038/nmat2835 (2010).
28 Someya, T. et al. A large-area, flexible pressure sensor matrix with organic field-effect transistors for artificial skin applications. P Natl Acad Sci USA 101, 9966-9970, doi:10.1073/pnas.0401918101 (2004).
29 Zhu, B. W. et al. Microstructured Graphene Arrays for Highly Sensitive Flexible Tactile Sensors. Small 10, 3625-3631, doi:10.1002/sm11.201401207 (2014).
30 Dahiya, R. S. & Valle, M. Robotic tactile sensing: technologies and system. (Springer Science & Business Media, 2012).
31 Radhakrishnan, G., Cardema, J. D., Adams, P. M., Kim, H. I. & Foran, B. Fabrication and Electrochemical Characterization of Single and Multi-Layer Graphene Anodes for Lithium-Ion Batteries. J Electrochem Soc 159, A752-A761, doi:10.1149/2.052206jes (2012).
32 Wei, D. et al. Ultrathin rechargeable all-solid-state batteries based on monolayer graphene. J Mater Chem A 1, 3177-3181, doi:10.1039/c3ta01183f (2013).
33 Suo, Z., Ma, E. Y., Gleskova, H. & Wagner, S. Mechanics of rollable and foldable film-on-foil electronics. Applied Physics Letters 74, 1177-1179, doi:doi:http://dx.doi.orq/10.1063/1.123478 (1999).
34 Bae, S. et al. Roll-to-roll production of 30-inch graphene films for transparent electrodes. Nat Nano 5, 574-578, doi:http://www.nature.com/nnano/iournal/v5/n8/abs/nnano.2010.132.html#supplementary-information (2010).
35 Liang, X., Fu, Z. & Chou, S. Y. Graphene transistors fabricated via transfer-printing in device active-areas on large wafer. Nano Letters 7, 3840-3844 (2007).
36 Zhou, Y. & Loh, K. P. Making patterns on graphene. Advanced Materials 22, 3615-3620 (2010).
37 Zhou, Y. et al. Microstructuring of graphene oxide nanosheets using direct laser writing. Advanced Materials 22, 67-71 (2010).
38. Zhang, L. et al. Carbon-based materials as supercapacitor electrodes. Chem. Soc. Rev. 2009, 38, 2520-2531

All references referred to above are hereby incorporated by reference.

1. A touch sensor having a layered structure, the layers including:
a substrate; and
a touch-sensitive layer formed of single-layer graphene and having a plurality of coplanar electrodes formed therein.

2. The touch sensor according to claim 1 further including a coating layer formed on top of the touch-sensitive layer.

3. The touch sensor according to claim 2 wherein the coating layer is formed of a polymer.

4. The touch sensor according to claim 1 wherein the sensor is sensitive to pressure as well as touch.

5. The touch sensor according to claim 4 wherein the capacitance between the electrodes varies in relation to the pressure applied to the sensor.

6. The touch sensor according to claim 1 wherein the coplanar electrodes are interdigitated.

7. The touch sensor according to claim 1 which is flexible.

8. The touch sensor according to claim 1 which is resiliently stretchable.

9. The touch sensor according to claim 1 wherein, apart from the substrate, the layers of the touch sensor are substantially transparent to near-infrared, visible and/or ultra-violet radiation.

10. The touch sensor according to claim 9 further including a photovoltaic layer capable of converting ambient radiation into electrical power, wherein the touch-sensitive layer and the polymer layer are stacked on top of the photovoltaic layer.

11. The touch sensor according to claim 10, further including a detection circuit configured to provide an output from the touch-sensitive layer, wherein the detection circuit is at least partly powered by the photovoltaic layer.

12. The touch sensor according to claim 10, further including an energy storage layer.

13. A prosthetic or robotic device having a touch-sensitive skin, wherein the touch-sensitive skin is formed of a plurality of touch sensors, each touch sensor comprising a layered structure, the layers comprising:
a substrate; and
a touch-sensitive layer formed of single-layer graphene and having a plurality of coplanar electrodes formed therein.

14. The prosthetic or robotic device according to claim 13, further including a control circuit, wherein the control circuit is configured to determine a point of contact of an external object with the touch-sensitive skin based on touch signals generated in the touch-sensitive layers of one or more of the touch sensors.

15. The prosthetic or robotic device according to claim 13,
wherein
apart from the substrate, the layers of the touch sensor are substantially transparent to near-infrared, visible and/or ultra-violet radiation,
each touch sensor further comprises a photovoltaic layer capable of converting ambient radiation into electrical power, wherein the touch-sensitive layer and the polymer layer are stacked on top of the photovoltaic layer, and
the movement of the prosthetic/robotic device is at least partly powered by the photovoltaic layers of one or more of the energy-autonomous touch sensors.

16. A method of manufacturing a touch sensor, the method including the steps of:
producing a sheet of single-layer graphene;
forming, using blade cutting, a plurality of interdigitated electrodes on the single-layer graphene.

17. The method according to claim 16 wherein the blade cutting is performed using a micrometric blade.

18. The method according to claim 16 wherein the sheet of single-layer graphene is produced by transfer printing the graphene onto a substrate.
